(19) United States
(12) Patent Application Publication
(10) Pub. No.: US 2025/0355997 A1
(43) Pub. Date: Nov. 20, 2025

(54) SYSTEM AND METHOD FOR REAL-TIME DETECTION OF CODE INTEGRITY VIOLATIONS

(71) Applicant: Daniel Boyle, Split (HR)

(72) Inventor: Daniel Boyle, Split (HR)

(21) Appl. No.: 19/280,350

(22) Filed: Jul. 25, 2025

(51) Int. Cl. G06F 21/55; G06F 11/34; G06F 21/31; G06F 21/57

(52) U.S. Cl. CPC G06F 21/55; G06F 11/3438; G06F 21/316; G06F 21/577

(57) ABSTRACT

A system and method are provided for real-time detection of code integrity violations by combining behavioral stylometry, biometric fingerprinting, and environmental threat analysis. Baseline data of a user's coding style such as indentation, variable naming, and keystroke patterns are stored and compared to live input to calculate deviation scores. Typing behaviors like dwell time, rhythm, and simulated pressure form a biometric fingerprint, while environmental scans detect suspicious network activity, browser extensions, or virtual machine use. A combined risk score is generated, and automated interventions are triggered when it exceeds a threshold, enabling early detection of unauthorized access, AI-generated code, or compromised environments for secure software development.

### FIELD OF THE INVENTION

The present disclosure generally relates to computer-implemented systems for real-time code analysis, and more particularly, to systems and methods for detecting code integrity violations using stylometric analysis, behavioral biometrics, and environmental threats.

### BACKGROUND OF THE INVENTION

As artificial intelligence becomes increasingly integrated into software development workflows, distinguishing between human-written and machine-generated code has become a growing challenge. In collaborative or sensitive coding environments, such as enterprise repositories, educational platforms, or regulatory systems, maintaining the authenticity and authorship of source code is critical for auditing, intellectual property management, and ethical compliance. Traditional code plagiarism detectors primarily rely on static similarity analysis, which fails to capture dynamic indicators of AI involvement or behavioral anomalies during the code-writing process.

Conventional developer authentication mechanisms, such as user login credentials or commit histories, offer only surface-level validation of authorship. These mechanisms do not account for the nuanced behavioral patterns unique to each programmer, such as typing rhythm, syntax preferences, or decision-making under time constraints. Furthermore, modern code editors increasingly support AI-assist tools (e.g., autocomplete, Copilot), creating blurred lines between human effort and machine generation, often without a clear audit trail or indication of AI involvement.

Existing code integrity solutions are fragmented, focusing either on static code analysis, post-hoc plagiarism checks, or superficial metadata audits. Few systems offer real-time, behavior-aware detection that combines stylometric patterns, behavioral biometrics, and environmental threat signals to assess the legitimacy of coding activity. Additionally, there is little integration between these systems and proactive intervention protocols that could prevent misuse or alert stakeholders during anomalous coding sessions.

Accordingly, there exists a need for a real-time system that may detect code integrity violations.

### SUMMARY OF THE INVENTION

The present disclosure provides a computer-implemented method and an associated system for detecting anomalies in coding behavior using behavioral biometrics, stylometric analysis, and environmental threat scanning. The method comprises storing, in a memory, baseline data representing a user's historical coding behavior, including indentation style, bracket usage, variable naming conventions, and keystroke biometrics; receiving current coding input from the user during an active session; calculating a deviation score based on differences in stylometric patterns between the current input and the baseline data; extracting a behavioral biometric fingerprint from the current input comprising dwell time, flight time, typing rhythm, and simulated keystroke pressure; and detecting environmental threats by scanning for indicators such as browser extension activity, virtual machine usage, and anomalous network behavior. A risk score is generated based on these inputs, and one or more automated interventions are triggered when the score exceeds a predefined threshold.

The present disclosure also provides a system and method for dynamically managing real-time interventions based on the computed risk score. The intervention module initiates responsive actions including warnings, logging violations, allowing auto-recovery from temporary anomalies, or terminating the session. The system enables secure software development practices by continuously validating user authenticity, detecting AI-generated code insertions, and identifying environmental compromise using integrated machine learning algorithms.

The method and associated system of the present disclosure overcome one or more of the shortcomings of the prior art. Additional features and advantages may be realized through the techniques of the present disclosure. Other embodiments and aspects of the disclosure are described in detail herein and are considered a part of the claimed disclosure.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 shows a block diagram of a code integrity monitoring system in accordance with some embodiments of the present disclosure;

FIG. 2 shows a detailed block diagram illustrating a code integrity monitoring server in accordance with some embodiments of the present disclosure;

FIG. 3 shows a flow diagram of an example code integrity violations detection method in accordance with some embodiments of the present disclosure;

FIG. 4 shows schematic representations of an example computer-readable storage medium in accordance with some embodiments of the present disclosure; and

FIG. 5 shows an example of real-time intervention during a coding session in accordance with some embodiments of the present disclosure.

Like reference numerals refer to like parts throughout the several views of the drawings.

### DETAILED DESCRIPTION

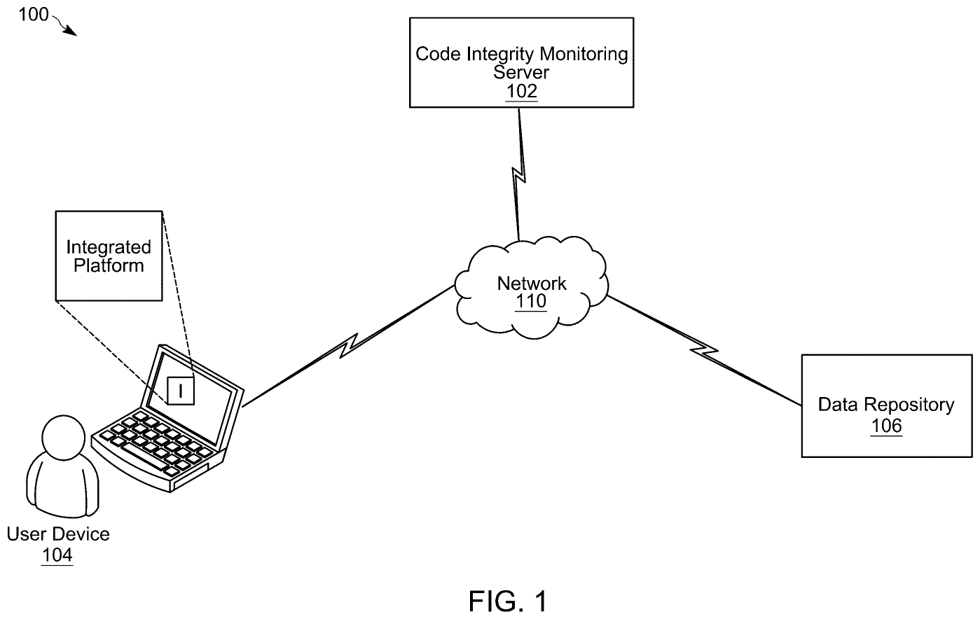

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless the context requires otherwise, throughout the specification and claims which follow, the word “comprise” and variations thereof, such as, “comprises” and “comprising” are to be construed in an open, inclusive sense, that is as “including, but not limited to.”

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the implementations.

The present disclosure describes a system and method for real-time detection of code integrity violations using behavioral biometrics, stylometric analysis, and environmental threat intelligence. The system comprises a code integrity monitoring server configured to receive live coding inputs from a user during an active session via an integrated development environment (IDE) or secure coding interface. The system stores historical baseline data representing the user's typical coding style, including indentation preferences, bracket and brace formatting, variable naming conventions, and keystroke biometrics. During operation, the system calculates a deviation score by comparing current coding behavior to the baseline profile using machine learning models. Simultaneously, a behavioral biometric fingerprint is extracted using metrics such as dwell time, flight time, typing rhythm, and simulated keystroke pressure. The system also performs environmental threat detection by scanning for indicators such as browser extensions, virtual machine artifacts, and anomalous network traffic. A composite risk score is computed using these data streams, and when the risk exceeds a predefined threshold, the system triggers one or more interventions, including issuing warnings, flagging violations, recovering from temporary anomalies, or terminating the session. The system further includes modules for incremental learning, dynamic risk threshold adjustment, privacy and access control, and forensic audit logging. Together, these components provide a robust framework for securing software development workflows against AI-generated code insertions, insider threats, and context spoofing in real time.

Referring initially to FIG. 1, which illustrates an example code integrity monitoring system 100 in accordance with some embodiments of the present disclosure. The code integrity monitoring system 100 comprises a code integrity monitoring server 102, a user device 104, and a data repository 106. These components are interconnected via a network 110, which may include the Internet or any other form of communication infrastructure capable of secure and low-latency data exchange.

The code integrity monitoring system 100 is designed to detect violations of coding integrity in real time by analyzing a user's live programming behavior. In some embodiments, the system 100 utilizes a multi-modal analysis engine capable of evaluating stylometric features, behavioral biometrics, and environmental context to determine whether the code is likely authored by the user or artificially generated by an AI system. Further, the code integrity monitoring system 100 also supports active intervention in response to high-risk sessions by issuing warnings, auto-recovering from anomalies, or terminating the session.

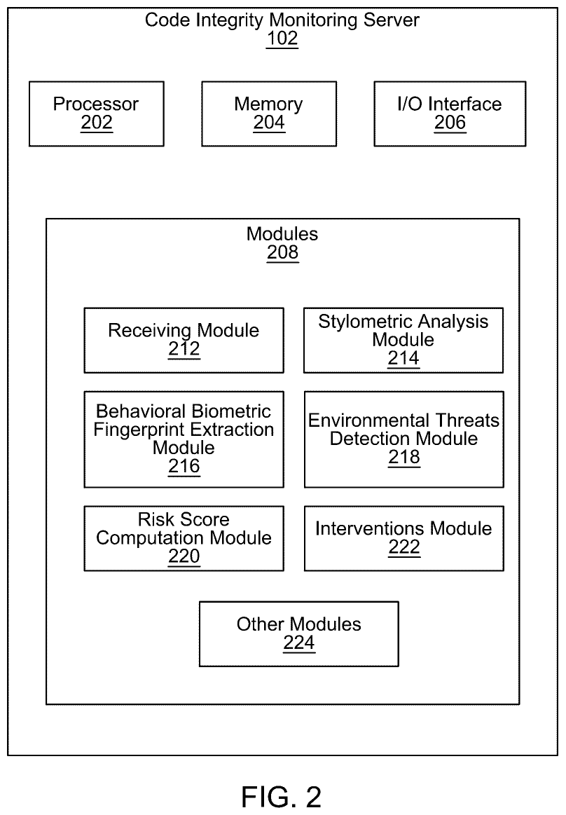

The code integrity monitoring server 102 serves as the central decision engine of the code integrity monitoring system 100. In some embodiments, the code integrity monitoring server 102 is configured to receive live code input data from the user device 104, execute machine learning algorithms to calculate a deviation score by comparing current input against a stored baseline, and generate a real-time risk score by incorporating behavioral biometric patterns and potential environmental threats. The code integrity monitoring server 102 may host various components as discussed in relation to FIG. 2 to perform one or more operations, such as determining whether a coding session exhibits signs of automated or assisted code generation. Further, the code integrity monitoring server 102 hosts an integrated platform, which is provided on the user device 104, that can detect violations of coding integrity.

The user device 104 functions as the primary interface through which the user interacts with the code integrity monitoring system 100. In some embodiments, the user device 104 may include a laptop, desktop computer, or any input-enabled terminal that supports an integrated platform for real-time coding. The integrated platform may be implemented as a plugin, web-based environment, or embedded IDE module that captures and transmits real-time coding events (e.g., typing cadence, syntax structure, and environment metadata) to the code integrity monitoring server 102. For instance, the user may engage in a timed programming assessment, during which the integrated platform continuously streams telemetry to the code integrity monitoring server 102 for analysis.

The integrated platform on the user device 104 is capable of performing lightweight preprocessing tasks, such as extracting indentation patterns, tracking copy-paste behavior, or measuring burst typing sequences. Further, it also acts as a local agent that can issue preliminary warnings or lock the interface if instructed by the code integrity monitoring server 102 based on detected integrity violations. In some embodiments, the integrated platform maintains a secure channel with the code integrity monitoring server 102 to facilitate encrypted and low-latency interaction during sensitive assessments.

The data repository 106 is configured to store persistent and session-based data required for the functioning of the code integrity monitoring system 100. This includes each user's historical coding baseline, computed behavioral fingerprints, real-time telemetry logs, session summaries, machine learning models, and decision thresholds. In some embodiments, the data repository 106 may also store anonymized training datasets, labeled event sequences to improve model performance, and audit logs for compliance reporting or retrospective review of flagged sessions.

The network 110 facilitates communication between the components of the code integrity monitoring system 100, including the user device 104, the code integrity monitoring server 102, and the data repository 106. In some embodiments, the network 110 supports secure protocols such as HTTPS, WebSocket Secure (WSS), and encrypted RESTful APIs to ensure both data confidentiality and real-time responsiveness. In some other embodiments, the network 110 may further support dynamic bandwidth allocation or adaptive transmission for environments with intermittent connectivity.

FIG. 2 shows a detailed block diagram illustrating the code integrity monitoring server 102 in accordance with some embodiments of the present disclosure. The code integrity monitoring server 102 is a critical component of the code integrity detection system 100 described in FIG. 1, and is responsible for receiving, analyzing, and verifying the authenticity of real-time coding inputs based on behavioral stylometry, biometric signals, and environmental threat cues. In some implementations, the code integrity monitoring server 102 comprises a processor 202, a memory 204, an input/output (I/O) interface 206, and one or more modules 208.

The processor 202 may be configured to execute computer-executable instructions for performing code behavior analysis, computing stylometric deviations, and orchestrating threat detection and intervention protocols. The memory 204 may include volatile or non-volatile memory (e.g., RAM, ROM, flash memory) that stores baseline user coding behavior data, pre-trained machine learning models, and real-time session logs. The I/O interface 206 is configured to enable communication between the server 102 and external entities, such as the user device 104 and the data repository 106, over the network 110.

In accordance with various embodiments, the modules 208 represent specialized functional units implemented in software, hardware, or firmware, and are executed in coordination with the processor 202. These modules work in tandem to detect AI-generated code, flag behavioral anomalies, and safeguard the integrity of the software development process.

The receiving module 212 is configured to capture and preprocess real-time coding input from a user during an active development session and serves as the front-line data acquisition component of the code integrity monitoring server 102. In operation, the receiving module 212 interfaces with the integrated platform installed on the user device 104, such as an IDE plugin, terminal emulator, browser-based editor, or standalone software development environment. As the user begins coding, the receiving module 212 continuously receives raw character-level input, key event metadata (e.g., key-down, key-up timestamps), input stream identifiers (e.g., source file name, programming language, cursor location), and contextual data such as focus-shift events, clipboard pastes, and file switch history.

To ensure integrity and completeness of session data, the receiving module 212 may implement event buffering, timestamp normalization, and input segmentation techniques. For instance, keystroke events may be batched into windowed intervals (e.g., 10-second segments) to align with biometric fingerprinting windows or stylometric block analysis. These data packets are tagged with session-specific metadata such as user ID, session start time, and device fingerprint, and are securely transmitted to the server via encrypted communication protocols (e.g., HTTPS, WSS, or TLS). In some embodiments, the receiving module 212 may implement forward error correction or retry logic to handle packet loss or low-bandwidth environments.

Further, in some embodiments, the receiving module 212 is designed to be passive and lightweight to avoid introducing latency into the coding workflow. Further, the receiving module 212 operates in real time, with sub-millisecond delay per event, and supports throttling or dynamic sampling in low-power environments. In enhanced implementations, the receiving module 212 may also capture additional telemetry data such as mouse events (e.g., click patterns near code), editor commands (e.g., “Find and Replace”, auto-complete usage), or speech-to-code inputs if voice-based interfaces are enabled.

For example, consider a developer named Arjun coding in Visual Studio Code using an integrated plugin. As Arjun types, the receiving module 212 captures each keystroke with its associated timestamp, editor state, and filename. When Arjun pastes a large block of code, the receiving module 212 detects the paste action, notes the clipboard source, and flags it for further stylometric analysis. If Arjun frequently switches between files or pauses for long intervals, the receiving module 212 records these interactions for time-based rhythm modeling. All of this data is securely packaged and sent to downstream modules, such as the stylometric analysis module 214 and the behavioral biometric fingerprint extraction module 216.

The stylometric analysis module 214 is configured to analyze stylistic characteristics of source code written by a user during an active coding session and to quantify deviations from an established baseline representing the user's authentic coding style. In some embodiments, the stylometric analysis module 214 plays a central role in the behavioral modeling aspect of the system by treating source code not only as functional logic but also as a behavioral artifact reflective of an individual's unique writing style, akin to a digital fingerprint. The stylometric analysis module 214 operates on both lexical and structural dimensions of the code and is capable of extracting high-resolution stylometric features in real time.

In some embodiments, the stylometric analysis module 214 receives time-synchronized code input segments from the receiving module 212, and parses them using a multilayered analysis pipeline. At the first layer, syntactic parsers tokenize the code into identifiable language constructs such as keywords, brackets, operators, variables, functions, and comments. The second layer applies pattern recognition techniques and rule-based heuristics to extract stylometric features such as indentation depth and consistency (e.g., tabs vs. spaces, mixed alignment), bracket placement style (e.g., K&R vs. Allman), naming conventions (e.g., camelCase vs. snake_case), comment density and formatting (e.g., use of inline vs. block comments), and code structure symmetry (e.g., function nesting depth, loop usage patterns). At the third layer, the stylometric analysis module 214 applies statistical normalization and dimensionality reduction techniques to encode the extracted features into a compact stylometric signature vector.

Further, the stylometric analysis module 214 maintains a dynamic baseline profile for each user, which represents their long-term habitual coding style derived from prior authenticated sessions. During each active session, the stylometric analysis module 214 computes a deviation score by comparing the incoming stylometric signature vector against the baseline profile using similarity measures such as cosine distance, Euclidean distance, Mahalanobis distance, or learned embedding distance in a neural latent space. This deviation score serves as one of the core indicators for identifying potential anomalies, such as the injection of AI-generated code or unauthorized human collaboration.

For example, consider a developer named Maya who habitually uses two-space indentation, camelCase variable names, and places opening brackets on the same line. Over time, these traits are codified into her stylometric baseline. During a particular session, if Maya suddenly switches to four-space indentation, uses snake_case, and includes block comments in a foreign language, particularly in sections of the code she pastes in quickly, this deviation is captured by the stylometric analysis module 214. The resulting deviation score increases significantly, triggering closer scrutiny by downstream modules such as the Risk Score Computation Module 220.

In some implementations, the stylometric analysis module 214 is also be configured to use one or more machine learning models trained on large corpora of human-written and AI-generated code. These models classify stylistic features and learn latent distributions that distinguish between human-authored content and machine-generated output. Examples of models include transformer-based classifiers (e.g., CodeBERT, GPT detectors), recurrent neural networks, and ensemble tree-based models that predict authorship probability. When enabled, this classification functionality augments the deviation score with an AI-likelihood probability, indicating how likely a given code segment was generated by an AI system.

To maintain robustness and adaptability, the stylometric analysis module 214 may be configured to operate in either static or adaptive profiling mode. In static mode, a user's baseline style is treated as fixed and deviations are measured strictly. In adaptive mode, the stylometric analysis module 214 incrementally updates the baseline profile over time using weighted averaging, forgetting factors, or confidence thresholds, thus accounting for natural evolution in a user's style while resisting short-term anomalies or adversarial obfuscation.

In some embodiments, the stylometric analysis module 214 also performs temporal segmentation of a session's input stream to detect local anomalies within continuous coding sessions. For instance, a sudden shift in indentation style for only one function, while the rest of the file conforms to the baseline, may indicate a pasted or injected segment. The stylometric analysis module 214 flags such local deviations and marks them with segment-level deviation scores, which are later used to drive targeted interventions, such as highlighting the suspicious block or flagging it for manual review.

The behavioral biometric fingerprint extraction module 216 is configured to generate a unique behavioral signature of the user based on keystroke-level biometric characteristics observed during a coding session. In some embodiments, the behavioral biometric fingerprint extraction module 216 analyzes fine-grained temporal and spatial patterns in user input, specifically how code is typed, rather than what is typed, to derive a biometric profile that reflects the user's motor patterns, typing habits, and cognitive rhythm. These behavioral biometrics serve as a robust identity signal that is difficult to imitate or spoof, providing an additional authentication layer and enabling real-time detection of anomalous user activity.

In some embodiments, the behavioral biometric fingerprint extraction module 216 captures keystroke dynamics including, but not limited to, dwell time (how long a key is held down), flight time (the interval between releasing one key and pressing the next), typing rhythm consistency, typing bursts and pauses, average words-per-minute, backspace/delete behavior, correction patterns, and repeated key usage. Advanced implementations may also estimate simulated pressure or key actuation strength in environments where such signals can be inferred, such as from keyboard event jitter, high-frequency polling data, or connected pressure-sensitive input devices.

The behavioral biometric fingerprint extraction module 216 continuously receives keystroke data streamed from the user device 104 via the receiving module 212. The input is processed using signal smoothing and noise reduction filters to remove artifacts caused by hardware variability or background activity. The behavioral biometric fingerprint extraction module 216 segments the keystroke stream into time windows (e.g., 10-30 seconds) or context windows (e.g., per function or block of code) and extracts a feature vector for each window using statistical, frequency-domain, and machine learning techniques. These vectors are then aggregated to form a session-level behavioral biometric fingerprint.

For example, a developer named Omar consistently types with fast bursts followed by pauses, exhibits longer dwell times on symbols like { and ;, and frequently uses backspace to correct short variable names. This pattern is stable across sessions and becomes encoded in his behavioral biometric profile. If, during a monitored session, the behavioral biometric fingerprint extraction module 216 detects a change in cadence such as significantly faster, smoother typing with minimal corrections, this may indicate that another user is typing or that the code was pasted from an external source, possibly aided by an AI tool. The behavioral biometric fingerprint extraction module 216 flags this behavioral divergence and forwards it to the risk score computation module 220.

To quantify the degree of deviation from the expected behavioral profile, the behavioral biometric fingerprint extraction module 216 computes a biometric deviation score. This score may be derived using distance-based methods (e.g., dynamic time warping, cosine similarity) or machine learning classifiers trained to differentiate genuine vs. imposter biometric signatures. The score is correlated with stylometric deviations, environmental threat signals, and contextual metadata (e.g., IP address, time of day) to assess the overall risk of integrity violation.

In some embodiments, the behavioral biometric fingerprint extraction module 216 incorporates adaptive learning to account for natural variation in typing behavior due to fatigue, stress, or device changes. The behavioral fingerprint can be updated gradually using confidence-weighted averaging or anomaly-aware Bayesian models, allowing the system to tolerate minor drifts while still detecting substantial identity inconsistencies or automation artifacts.

Further, the behavioral biometric fingerprint extraction module 216 may be integrated with a library of population-level biometric templates or anonymized behavior clusters. This allows the behavioral biometric fingerprint extraction module 216 to cross-reference a user's current session with known legitimate styles or known suspicious patterns (e.g., robotic typing indicative of copy-paste automation), thereby improving both precision and recall of anomaly detection.

In some implementations, the behavioral biometric fingerprint extraction module 216 supports real-time intervention triggers based on biometric thresholds. For example, if the biometric fingerprint of the session falls below a confidence threshold for identity match, the system may issue a live challenge (e.g., CAPTCHA, re-authentication), suspend the session temporarily, or notify an administrator. These actions are orchestrated through the interventions module 222, based on real-time feedback from the behavioral biometric fingerprint extraction module 216.

The environmental threats detection module 218 is configured to detect contextual anomalies in the user's coding environment that may indicate external compromise, unauthorized surveillance, or the use of non-human execution platforms such as virtual machines or automated AI agents. In some embodiments, the environmental threats detection module 218 continuously monitors system-level and network-level signals to uncover indicators of tampering, virtualization, remote control, or covert observation, thus safeguarding the code generation environment from exfiltration, automation misuse, or adversarial manipulation.

In some embodiments, the environmental threats detection module 218 is designed to operate in parallel with other previously explained modules. While those modules analyze how the code is written, the environmental threats detection module 218 examines where and under what conditions the code is being produced. For instance, even if the typing appears human, the presence of unauthorized browser extensions, network proxies, or active virtual machines may indicate risk factors that influence the trustworthiness of the coding session.

In some embodiments, the environmental threats detection module 218 employs multiple threat detection engines, including browser extension scanners, hardware fingerprint validators, network anomaly detectors, and virtualization artifact analyzers. Each subcomponent targets a specific layer of the environment. The browser extension scanner queries known extension registries and inspects active browser contexts (with user permission) to detect code-suggesting plugins, AI co-pilots, clipboard interceptors, or session recording tools. If detected, these plugins are flagged with associated risk weights depending on their known behavior (e.g., suggestion-only vs. autonomous rewriting).

The hardware fingerprint validator checks for inconsistencies between expected user hardware (e.g., input device identifiers, OS fingerprints, graphics/rendering stacks) and the current session's system parameters. For example, if a developer typically codes from a MacBook Pro with a US keyboard layout, but the current session runs on a Linux VM with generic input devices and a mismatched keyboard map, the environmental threats detection module 218 raises a suspicion score. Such inconsistencies may suggest the use of remote desktops, disposable VMs, or stealthy browser environments used to avoid attribution.

The network anomaly detector scans for signs of unusual traffic routing or tunneling behavior. This includes proxy chaining, the use of anonymizing VPNs, DNS over HTTPS activity anomalies, or known C2 (command-and-control) patterns. IP geolocation, latency analysis, packet inspection (when allowed), and handshake profiling are used to build a real-time network threat context. For example, if a user in New York initiates a session, but network telemetry indicates a London-based exit node or rapid geolocation switching, the system may classify the session as high risk and flag it accordingly.

The virtualization artifact analyzer identifies markers of VM-based execution environments, such as hypervisor process footprints, sandboxing traces, emulation lags, MAC address prefixes associated with virtual NICs, or BIOS/firmware inconsistencies. These indicators help the system determine whether the session is running in a synthetic environment, which may be used by attackers to bypass behavioral biometrics, simulate inputs, or inject auto-generated code segments.

For example, a developer named Trina logs in to her usual coding platform, but the environmental threats detection module 218 detects the presence of a previously unseen browser extension named “CodeAssist++,” known for real-time code injections. At the same time, her session shows signs of running within a headless VM with no display interface and anomalous network latency suggestive of tunneling through a remote server. Based on these multi-layered indicators, the environmental threats detection module 218 assigns an elevated environmental threat score and forwards this to the risk score computation module 220.

The risk score computation module 220 is configured to synthesize and quantify multiple threat vectors into a unified, actionable risk score, including stylometric deviations, behavioral biometric anomalies, and environmental inconsistencies. This score serves as a predictive indicator of potential code integrity violations and informs whether intervention protocols should be triggered in real time. The risk score computation module 220 functions as a central decision-making engine that assesses both the probability and severity of a compromise or automation-assisted code injection, enabling fine-grained control over developer workflows without unnecessarily disrupting legitimate sessions.

In some embodiments, the risk score computation module 220 operates by aggregating sub-scores received from three primary sources: (1) the stylometric analysis module 214, which reports on deviations in code formatting and writing style; (2) the behavioral biometric fingerprint extraction module 216, which tracks physical user interaction patterns such as typing cadence, rhythm, and pressure signatures; and (3) the environmental threats detection module 218, which evaluates the user's technical environment for virtualization, proxy routing, unauthorized plugins, and session obfuscation. Each sub-score is normalized and associated with a context-specific weight to reflect its relative reliability and threat potential.

The risk score computation module 220 uses a dynamic weighting scheme, where the contribution of each signal can vary based on contextual factors. For example, if a user is writing code from a known secure device but exhibits major stylometric anomalies and biometric inconsistencies, the model may prioritize content-based indicators over environmental context. Conversely, if the stylometric style matches the user's baseline but the session is taking place from an unknown device routed through multiple proxies, the system may raise the risk score based on environmental red flags. This ensures that the model is adaptive and resilient to adversarial behavior such as spoofing or mimicry.

The computation logic within the risk score computation module 220 can be implemented using rule-based algorithms, statistical models, or machine learning classifiers, such as gradient-boosted decision trees, ensemble methods, or neural scoring networks trained on historical incident data. These models may be periodically retrained on anonymized violation events to improve predictive accuracy and reduce false positives. In some embodiments, the risk score computation module 220 includes an explainability interface that decomposes the final score into human-readable components, such as: “+0.25 for rapid typing inconsistent with historical cadence,” “+0.40 for active VM presence,” or “+0.35 for variable naming mismatch with past 20 sessions.”

The risk score is computed on a rolling basis during an active coding session. As new input is received, keystroke bursts, new code blocks, or environment state changes, the risk score computation module 220 continuously updates the score, allowing for dynamic intervention decisions. For example, a session may initially begin with a low risk score, but as stylometric and biometric anomalies accumulate, the score may cross a predefined threshold that triggers system responses (e.g., warnings, user re-authentication, or session termination).

In some embodiments, the risk score computation module 220 distinguishes between temporary anomalies and persistent risks. For instance, a spike in typing speed may be tolerated if it returns to baseline within a short time window. This temporal smoothing reduces false positives caused by momentary shifts in behavior (e.g., caffeine use, fatigue, emotional stress) while still flagging sustained deviations that may indicate external influence or AI injection.

For example, a developer named Priya normally writes Python code with consistent indentation and a calm typing pattern. During one session, the stylometric analysis module 214 flags abrupt shifts in formatting (e.g., unusual nesting, inconsistent whitespace), and the behavioral biometrics fingerprint module 216 detects flight times too rapid to be human. Simultaneously, the environmental threat detection module 218 reports a sandboxed environment with anonymized IP routing. The risk score computation module 220 aggregates these indicators into a score of 0.89 on a scale of 0 to 1, exceeding the intervention threshold of 0.75. The system triggers an automated integrity review workflow while continuing to monitor for escalation.

In some implementations, the risk score computation module 220 supports contextual override logic, allowing enterprise administrators to customize risk thresholds based on project sensitivity, developer roles, or regulatory compliance requirements. For example, for critical systems code or financial software, the system may operate with a lower intervention threshold (e.g., 0.60) compared to non-critical sandboxed environments (e.g., 0.85).

The interventions module 222 is configured to execute one or more automated responses when the risk score computed by the risk score computation module 220 exceeds a predefined or dynamically adjusted threshold. The interventions module's 222 primary function is to preserve code integrity and ensure developer accountability by taking context-aware corrective actions during an active coding session. The interventions may range from non-intrusive alerts to aggressive measures such as session lockdown or developer re-verification, depending on the severity and duration of the detected anomalies.

In some embodiments, the interventions module 222 supports a tiered intervention strategy, with escalating actions based on risk levels. For instance, if the risk score crosses a low-risk threshold (e.g., 0.60), the interventions module 222 may issue a soft warning to the user, such as “Unusual coding pattern detected, please confirm activity.” At a medium-risk level (e.g., 0.75), the system may flag the session for internal audit, restrict code submission privileges, or require re-authentication using biometric, 2FA, or secure tokens. At high-risk thresholds (e.g., 0.90 and above), the interventions module 222 may automatically terminate the session, roll back recent changes, or isolate the session in a sandbox environment for post-event forensics.

Further, the interventions module 222 allows for customizable intervention rules, defined by system administrators or organizational policies. These rules may incorporate temporal logic (e.g., allow grace periods), project-criticality sensitivity (e.g., stricter responses for protected codebases), and user-specific tolerance levels (e.g., new hires vs. senior developers). In some configurations, the interventions are designed to be non-disruptive yet traceable, allowing developers to continue working under observation while generating an audit trail for security teams.

In one illustrative example, a developer named Anya is working on an enterprise banking application. The system detects stylometric anomalies inconsistent with Anya's usual code structure, biometric typing patterns that suggest automation, and the presence of remote desktop software. The computed risk score reaches 0.87, triggering a multi-layered intervention: (1) the user is immediately shown a pop-up requiring identity confirmation, (2) the session is marked for integrity review, and (3) recent code commits are routed to a quarantine queue where they require reviewer approval before merging. If Anya fails to confirm her identity within 5 minutes, the session is auto-terminated.

In some embodiments, the interventions module 222 supports automated anomaly recovery, especially in cases where the user may unintentionally deviate from normal behavior due to stress, fatigue, or network lag. In such cases, the interventions module 222 may temporarily suspend intervention or activate self-healing protocols, such as slowing down the pace, prompting the user to take a break, or launching a guided walkthrough to align behavior. If normal patterns resume, the intervention may be canceled without permanent disruption.

The one or more modules 208 may also comprise the other modules 224 to perform various miscellaneous functionalities of the code integrity monitoring server 102. It will be appreciated that such aforementioned modules may be represented as a single module or a combination of different modules. The modules may be implemented in the form of software implemented by a processor, hardware, and or firmware.

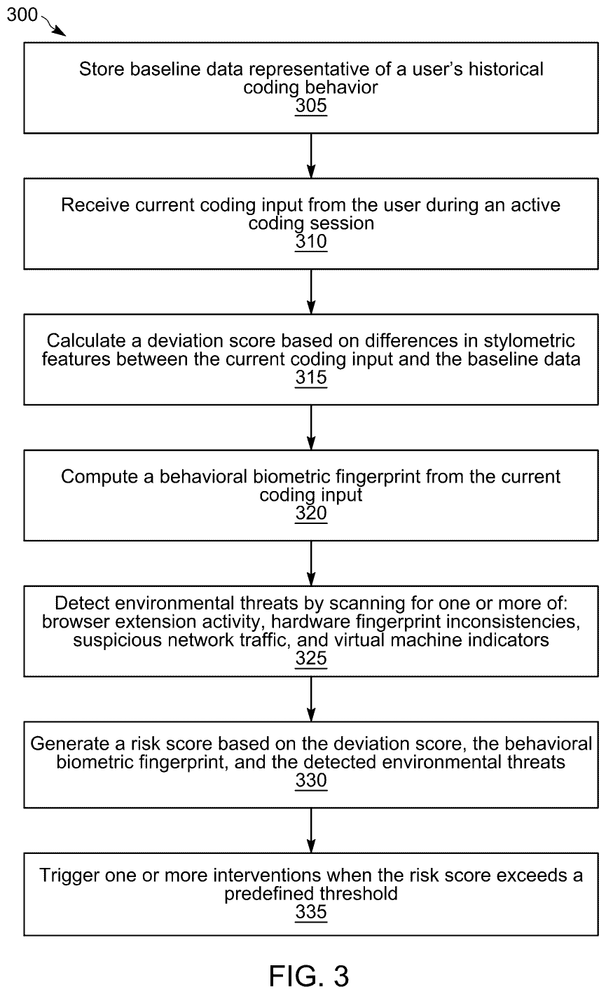

FIG. 3 is a flow diagram illustrating an example method 300 for detecting code integrity violations in real time, in accordance with some embodiments of the present disclosure. As illustrated in FIG. 3, the method 300 comprises one or more blocks implemented by the code integrity monitoring server 102. The method 300 may be described in the general context of computer-executable instructions. Generally, computer-executable instructions can include routines, programs, objects, components, data structures, procedures, modules, and functions that perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 305, the code integrity monitoring server 102 stores, in memory, baseline data representative of a user's historical coding behavior. This baseline data may include stylometric and biometric features, such as indentation style, bracket placement, variable naming conventions, and keystroke biometrics. These features serve as a unique behavioral signature of the developer and form the reference dataset against which future deviations will be assessed. For instance, a developer named Rohan consistently uses “camelCase” for variable names, places opening braces on new lines, and types at a steady rhythm with specific keystroke pressure patterns.

At block 310, during an active coding session, the system receives the current coding input from the user. This real-time stream may be captured through IDE plugins, secured logging modules, or integrated keylogger APIs. The system continuously monitors and logs live keystrokes, code structures, formatting patterns, and input timing. For example, as Rohan codes a new Python module, the system captures line-by-line code, including whitespace usage, syntax decisions, and keystroke timing information, without disrupting his workflow.

At block 315, the system calculates a deviation score based on observed differences in stylometric features between the incoming coding input and the previously stored baseline data. The stylometric features may include metrics such as indentation consistency, bracket placement fidelity, frequency of inline comments, and function naming regularity. The deviation score may be calculated using distance-based classifiers, anomaly detection algorithms, or stylometric fingerprint comparison models. For instance, if Rohan suddenly begins using “snake_case” or mixes indentation styles, the system may detect a stylometric drift and assign a preliminary deviation score of 0.62.

At block 320, the system computes a behavioral biometric fingerprint from the current coding input. This fingerprint includes metrics such as dwell time (how long each key is pressed), flight time (time between key presses), typing rhythm, and simulated keystroke pressure, either through direct hardware sensors or software inference. These features help confirm the human authenticity of the user and detect automation or remote access behavior. For example, if Rohan typically maintains a 0.15-second average flight time but the current session logs erratic patterns resembling robotic bursts or prolonged idle spikes, the fingerprint is flagged as inconsistent.

At block 325, the system performs environmental threat detection by scanning for anomalies such as browser extension activity, hardware fingerprint mismatches, suspicious outbound network traffic, and virtual machine (VM) indicators. These factors help assess whether the development environment is compromised, emulated, or hijacked. For example, if the system detects that Rohan's current session is being conducted from a VM with no prior record, and network telemetry shows a burst of encrypted connections to unknown IP addresses, the environmental threat score is increased significantly.

At block 330, the system generates a cumulative risk score based on the stylometric deviation score, behavioral biometric fingerprint, and environmental threat indicators. This risk score quantifies the probability that the current coding activity is unauthorized, automated, or otherwise malicious. The computation may use weighted scoring models, machine learning classifiers, or trust graphs. For instance, a combination of minor stylometric anomalies, moderate biometric deviation, and high environmental threat yields a risk score of 0.89—exceeding the predefined acceptable threshold for high-security projects.

At block 335, the system triggers one or more interventions if the risk score exceeds the configured threshold. These interventions may include issuing real-time warnings, locking the development session, routing code to a review queue, requesting re-authentication, or revoking developer access. For example, in Rohan's case, the system immediately issues a pop-up requiring biometric confirmation, pauses all Git commits, and sends a session log to the security operations team for review.

In some embodiments, the system may include a feedback loop where legitimate deviations are used to refine the baseline behavior model over time, allowing adaptation to changes in user habits without compromising security.

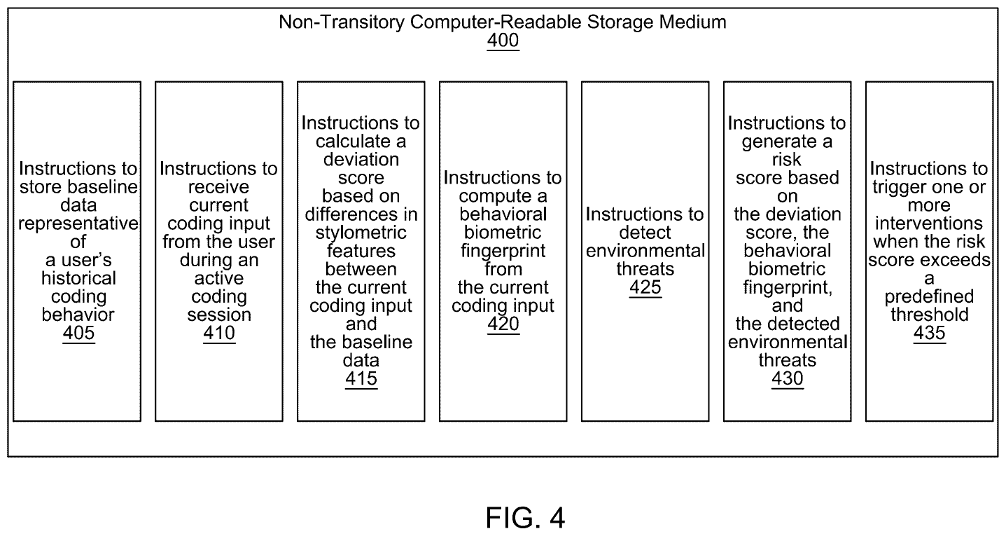

Turning now to FIG. 4, an example non-transitory computer-readable storage medium (CRSM) 400 is shown, in which CRSM 400 comprises instructions executable by the processor 202. The CRSM may comprise any electronic, magnetic, optical, or other physical storage device that stores executable instructions. The instructions may comprise instructions to cause the processor to perform or control performance of operations of the example method 300 and the other methods described herein. For example, the instructions may comprise instructions 405 to store baseline data representative of a user's historical coding behavior.

In addition, the instructions may comprise instructions 410 to receive current coding input from the user during an active coding session. Furthermore, the instructions may comprise instructions 415 to calculate a deviation score based on differences in stylometric features between the current coding input and the baseline data. Furthermore, the instructions may comprise instructions 420 to compute a behavioral biometric fingerprint from the current coding input. Furthermore, the instructions may comprise instructions 425 to detect environmental threats. Furthermore, the instructions may comprise instructions 430 to generate a risk score based on the deviation score, the behavioral biometric fingerprint, and the detected environmental threats. Furthermore, the instructions may comprise instructions 435 to trigger one or more interventions when the risk score exceeds a predefined threshold.

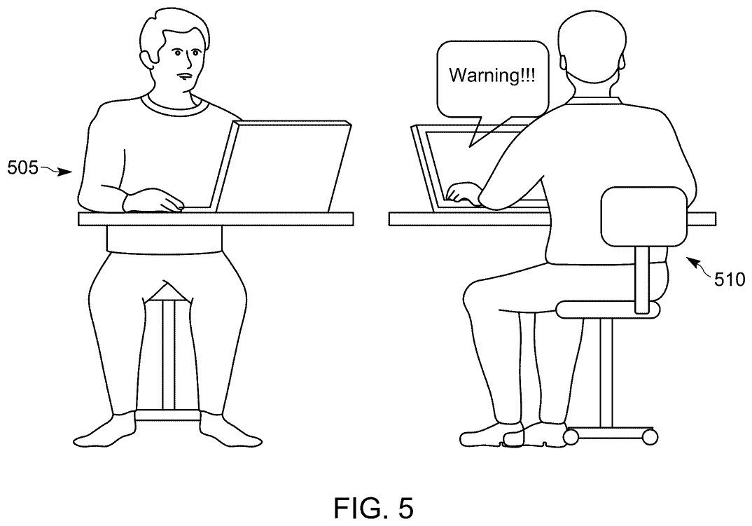

FIG. 5 shows an example of real-time intervention during a coding session in accordance with some embodiments of the present disclosure. As shown, a first user 505 continues coding normally without interruption, indicating that their behavior aligns with the established baseline profile.

In contrast, a second user 510 receives a “Warning!!!” alert on their screen, triggered by the code integrity monitoring system 100 when their coding behavior deviates significantly from the baseline. This deviation may result from unusual stylometric patterns, inconsistent biometric input, or detected environmental threats. Based on a computed risk score exceeding a threshold, the code integrity monitoring system 100 initiates an intervention, such as issuing a warning, to mitigate potential code integrity violations.

The methods described herein may be performed using the systems described herein. In addition, it is contemplated that the methods described herein may be performed using systems different than the systems described herein. Moreover, the systems described herein may perform the methods described herein and may perform or execute the instructions stored in the CRSMs described herein. It is also contemplated that the systems described herein may perform functions or execute instructions other than those described in relation to the methods and CRSMs described herein.

Furthermore, the CRSMs described herein may store instructions corresponding to the methods described herein, and may store instructions which may be performed or executed by the systems described herein. Furthermore, it is contemplated that the CRSMs described herein may store instructions different than those corresponding to the methods described herein, and may store instructions which may be performed by systems other than the systems described herein.

The methods, systems, and CRSMs described herein may include the features or perform the functions described herein in association with any one or more of the other methods, systems, and CRSMs described herein.

The above description of shown example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein may be combined to provide further implementations.

In some embodiments, the method or methods described above may be executed or carried out by a computing system (for example, the code integrity monitoring server 102) including a tangible computer-readable storage medium, also described herein as a storage machine, that holds machine-readable instructions executable by a logic machine (e.g., a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an API.

Since many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the invention should be determined by the appended claims and their legal equivalents.

1. A computer-implemented system for detecting code integrity violations in real time, the system comprising:
a memory configured to store baseline data representative of a user's historical coding behavior, the baseline data comprising one or more of: indentation style, bracket placement, variable naming conventions, and keystroke biometrics;
a processor operatively coupled to the memory and configured to execute instructions that cause the system to:
receive current coding input from a user during an active coding session;
calculate a deviation score based on differences in stylometric features between the received current coding input and the baseline data;
compute a behavioral biometric fingerprint of the user from the current coding input, wherein the behavioral biometric fingerprint comprises one or more of: dwell time, flight time, typing rhythm, and simulated keystroke pressure;
detect environmental threats by scanning for one or more of: browser extension activity, hardware fingerprint inconsistencies, suspicious network traffic, and virtual machine indicators;
generate a risk score based on the calculated deviation score, the behavioral biometric fingerprint, and the detected environmental threats; and
trigger one or more interventions when the risk score exceeds a predefined threshold.

2. The system of claim 1, wherein the stylometric features comprise one or more of: indentation depth, spacing consistency, brace/bracket style, variable naming patterns, and comment formatting habits.

3. The system of claim 1, wherein the baseline data is continuously updated over time through incremental learning to reflect the evolving coding style of the user.

4. The system of claim 1, wherein the one or more interventions triggered in response to the risk score exceeding the predefined threshold comprise at least one of: issuing a warning to the user, flagging the current session for a potential code integrity violation, initiating automatic recovery from temporary behavioral anomalies, and terminating the coding session.

5. The system of claim 1, wherein to calculate a deviation score based on differences in stylometric features between the received current coding input and the baseline data, the processor is configured to:
compare the current coding behavior with the baseline profile using a machine learning model,

6. The system of claim 1, wherein the deviation score is based on one or more indicators of AI-generated code that comprises: sudden increases in code complexity, unnatural code structure, inconsistent naming conventions, and rapid typing patterns inconsistent with human behavior.

7. The system of claim 5, wherein the machine learning model is selected from at least one of: support vector machines (SVM), recurrent neural networks (RNN), convolutional neural networks (CNN), and transformer-based models.

8. The system of claim 1, wherein environmental threat detection comprises identifying one or more of: remote desktop sharing, clipboard hijacking activity, or screen mirroring.

9. The system of claim 1, wherein the predefined threshold for triggering the one or more interventions is dynamically adjusted based on contextual factors including session length, code complexity, and historical deviation patterns.

10. A computer-implemented method for detecting code integrity violations in real time, the method comprising:
storing, in a memory, baseline data representative of a user's historical coding behavior, the baseline data comprising one or more of: indentation style, bracket placement, variable naming conventions, and keystroke biometrics;
receiving, by a processor, current coding input from the user during an active coding session;
calculating, by the processor, a deviation score based on differences in stylometric features between the current coding input and the baseline data;
computing, by the processor, a behavioral biometric fingerprint from the current coding input, the biometric fingerprint comprising one or more of: dwell time, flight time, typing rhythm, and simulated keystroke pressure;
detecting, by the processor, environmental threats by scanning for one or more of: browser extension activity, hardware fingerprint inconsistencies, suspicious network traffic, and virtual machine indicators;
generating, by the processor, a risk score based on the deviation score, the behavioral biometric fingerprint, and the detected environmental threats; and
triggering, by the processor, one or more interventions when the risk score exceeds a predefined threshold.

11. The method of claim 10, wherein the stylometric features comprise one or more of: indentation depth, spacing consistency, brace or bracket style, variable naming patterns, and comment formatting habits.

12. The method of claim 10, further comprising incrementally updating the baseline data over time to reflect changes in the user's coding behavior using a machine learning model.

13. The method of claim 10, wherein the one or more interventions triggered in response to the risk score exceeding the predefined threshold comprise at least one of: issuing a warning to the user; flagging the coding session for review; initiating automatic recovery from temporary behavioral anomalies; and terminating the coding session.

14. The method of claim 10, wherein calculating the deviation score comprises comparing the current coding input with the baseline data using a machine learning model.

15. The method of claim 14, wherein the machine learning model is selected from at least one of: support vector machines (SVM), recurrent neural networks (RNN), convolutional neural networks (CNN), or transformer-based models.

16. The method of claim 10, wherein the deviation score is further based on one or more indicators of AI-generated code, including: sudden increases in code complexity; unnatural or repetitive code structures; inconsistent variable or function naming conventions; and typing burst patterns inconsistent with typical human behavior.

17. The method of claim 10, wherein detecting environmental threats further comprises identifying one or more of: remote desktop sharing; clipboard hijacking activity; and screen mirroring.

18. The method of claim 10, wherein the predefined threshold for triggering one or more interventions is dynamically adjusted based on contextual factors, including at least one of: session duration, code complexity, user access privileges, or deviation history.

19. A computer readable storage medium having data stored therein representing software executable by a computer, the software comprising instructions that, when executed, cause the computer readable storage medium to perform:
storing baseline data representative of a user's historical coding behavior, the baseline data comprising one or more of: indentation style, bracket placement, variable naming conventions, and keystroke biometrics;
receiving current coding input from the user during an active coding session;
calculating a deviation score based on differences in stylometric features between the current coding input and the baseline data;
computing a behavioral biometric fingerprint from the current coding input, the biometric fingerprint comprising one or more of: dwell time, flight time, typing rhythm, and simulated keystroke pressure;
detecting environmental threats by scanning for one or more of: browser extension activity, hardware fingerprint inconsistencies, suspicious network traffic, and virtual machine indicators;
generating a risk score based on the deviation score, the behavioral biometric fingerprint, and the detected environmental threats; and
triggering one or more interventions when the risk score exceeds a predefined threshold.

20. The computer readable storage medium of claim 19, wherein the stylometric features comprise one or more of: indentation depth, spacing consistency, brace or bracket style, variable naming patterns, and comment formatting habits.
